(19) United States
(12) Patent Application Publication
(10) Pub. No.: US 2007/0293410 A1
(43) Pub. Date: Dec. 20, 2007

(54) Contact lens and method for preventing contact lens intolerance

(76) Inventor: Richard J. Surowiak, Aurora, IL (US)

Correspondence Address: THE LAW OFFICE OF RANDALL T. ERICKSON, P.C., 1749 S. NAPERVILLE ROAD, SUITE 202, WHEATON, IL, 60187, US

(21) Appl. No.: 11/453,944

(22) Filed: Jun. 15, 2006

(51) Int. Cl. C11D 3/00

(52) U.S. Cl. 510/112

(57) ABSTRACT

A method of treating contact lens intolerance includes the steps of: providing a solution comprising an essential fatty acid, and applying the solution to a surface of the contact lens. Preferably, the essential fatty acid is an omega-3 fatty acid. The contact lens can be soaked in a container holding a supply of the solution, or the solution can be applied via a dropper directly to the contact lens in the eye or while on a surface or in a container. The contact lens can have the solution applied during manufacture as a part of the contact lens material or as a solution saturated into the contact lens.

### FIELD OF THE INVENTION

The present invention relates to the treatment of contact lens intolerance by administering compositions comprising an essential fatty acid, particularly omega-3 fatty acid.

### BACKGROUND OF THE INVENTION

The tear layer of the eye is composed of three layers, the posterior (back) layer is a mucus/mucin layer, the center layer is an aqueous (water) layer, the anterior (front) layer is an oily layer. The oily layer functions to prevent aqueous evaporation. Dry eye syndrome is a condition wherein the anterior oily layer is reduced due to a deficiency in oil production from the meibomian glands. This is a pathological condition. A reduced oily layer causes an increased aqueous evaporation, which causes discomfort known as “dry eye syndrome.”

U.S. patent application 20060009522A1, herein incorporated by reference, discloses a method to alleviate dry eye syndrome using topically applied eye drops containing essential fatty acids such as Omega-3 and Omega-6.

The present invention is directed to a condition called “contact lens intolerance.” Contact lenses in wide use today fall into two general categories. Hard type lenses are formed from materials prepared by the polymerization of acrylic esters, such as poly(methyl methacrylate) (PMMA). Gel, hydrogel or soft type lenses are made by polymerizing such monomers as 2-hydroxyethyl methacrylate (HEMA) or, in the case of extended wear lenses, made by polymerizing silicon-containing monomers or macromonomers.

Soft contact lenses and extended wear lenses typically contains water, usually 38 to 60% or higher. Evaporation of water from within the contact lens causes the contact lens to replenish this water by absorption of water from the tear layer of the eye. If the tear layer is dehydrated the contact lens becomes uncomfortable and vision is compromised. This decreased vision and discomfort is known as “contact lens intolerance.” Contact lens wearers make up 90-100% of people using artificial tears/natural tears/rewetting drops to alleviate contact lens intolerance. Study show these medicaments do lubricate, however the effect lasts only minutes.

Thus, contact lens intolerance is a condition caused by the interaction between a contact lens and the eye, and can be distinguished from dry eye syndrome which is a characteristic of the eye, i.e., a deficiency in oil production from the meibomian gland. Contact lens intolerance can usually be alleviated by removing the contact lens. Eye discomfort and vision impairment caused by contact lens intolerance is a prevalent problem in eye care for contact lens wearers.

### SUMMARY OF THE INVENTION

The invention provides a method of treating contact lens intolerance and includes the steps of: providing a contact lens, providing a solution comprising an essential fatty acid, applying the solution to a surface of the contact lens.

Preferably, the method step of providing a solution is further defined in that the essential fatty acid is an omega-3 fatty acid.

The method step of applying the solution can be further defined by the steps of: providing a container holding a supply of the solution, and soaking the contact lens in the container.

Alternately, the method step of applying the solution can be further defined by the steps of: providing a bottle of the solution, and applying the solution onto the contact lens. The bottle can dispense drops of the solution onto the contact lens either while the contact lens is in the eye, or in a separate container.

According to another aspect of the invention, a method of manufacturing contact lenses includes the steps of forming a contact lens, providing a solution comprising an essential fatty acid and saturating the contact lens with the solution.

Preferably, the method step of providing a solution is further defined in that the essential fatty acid is an omega-3 fatty acid.

According to another aspect of the invention a contact lens is provided that is resistant to causing contact lens intolerance, the contact lens comprising a body portion forming a lens, wherein the body portion is saturated with a solution containing an essential fatty acid.

Preferably, the essential fatty acid is an omega-3 fatty acid.

According to the preferred methods and embodiments of the invention, a drop of solution containing omega-3 will mimic the oily layer deficiency caused by contact lens intolerance and hold the aqueous tear layer in tact.

If a solution comprised of omega-3 fatty acids is applied to coat the contact lens, water evaporation will be limited. Direct installation of omega-3 internal to the contact lens, in a manner that would not adversely effect oxygen transmissibility, will also limit water evaporation and prevent contact lens intolerance. Since contact lenses are comprised of polymers that mimic fatty acids, the external contact lens layer can contain a breathable omega-3 infusion and retain the water inside the contact lens, thus eliminating the propensity of the contact lens to remove aqueous (water) from the tear layer. An eyedrop or contact lens infusion containing omega-3 fatty acid should resolve contact lens intolerance.

Omega-3 fatty acids are found in cod liver oil, salmon oil, black currant, and flaxseed and are available in over-the-counter supplements that have been shown to improve the meibomian gland functioning.

The omega-3 fatty acid can be applied topically to an eye containing any contact lens material without side effect or damage to the contact lens as contact lenses are made of polymers containing fatty acid type properties in that they allow penetration of oxygen and retain a central zone of water.

The omega-3 fatty acids in a solution can replace the water saturated in, or held by, the contact lens and provide a longer evaporation time. The omega-3 fatty acids can be incorporated within the polymer of the lens material and provide a longer evaporation time. Even the application of omega-3 drops to the lens in the eye or in a separate container may penetrate a contact lens to a sufficient degree and prevent evaporation causing contact lens intolerance.

Numerous other advantages and features of the present invention will be become readily apparent from the following detailed description of the invention and the methods and embodiments thereof.

### DETAILED DESCRIPTION

While this invention is susceptible of embodiment in many different forms, there is described herein in detail, specific methods and embodiments thereof with the understanding that the present disclosure is to be considered as an exemplification of the principles of the invention and is not intended to limit the invention to the specific methods and embodiments described.

The preferred embodiment of the invention provides a method of treating contact lens intolerance and includes the steps of: providing a contact lens, providing a solution comprising an omega-3 fatty acid, and applying the solution to a surface of the contact lens. According to one method, a container holds a supply of the solution, and the contact lens is soaked in the container.

Alternately, the solution is provided in a dropper type bottle, and the solution is applied to the contact lens while in the eye. Alternatively, a bottle of solution can be used to dispense drops of the solution onto the contact lens while the contact lens is on a treatment surface or in an open container.

According to another aspect of the invention, an exemplary method of manufacturing contact lenses, and an exemplary contact lens made according to the method, includes the steps of forming a contact lens by a conventional method, providing a solution comprising an omega-3 fatty acid and saturating the contact lens with the solution.

The contact lens can be as described in U.S. patents U.S. Pat. Nos. 5,236,969; 5,532,289; 6,599,959; 6,630,243; 6,921,802; and 7,037,469, and made in any way described in U.S. Pat. Nos. 5,601,759; 5,968,422; 5,611970, all herein incorporated by reference.

There are two groups of unsaturated fatty acids that are considered essential to human health. These two groups include the omega-6 fatty acids derived from linoleic acid (LA) and the omega-3 fatty acids derived from alpha linolenic acid (ALA). LA is provided in the diet, from vegetable cooking oils, beef, and dairy. The omega-3 fatty acids are provided in the diet or from supplements, from oily fish, cod liver oil, or salmon oil, but they may also be synthesized in the body via conversion of ALA consumed in certain seeds (e.g., flaxseed, rape, chia, perilla and black currant) or leaves (e.g., purslane).

The present invention provides a contact lens treating solution comprising of at least one essential fatty acid. The solution can comprise at least one omega-6 fatty acid and/or at least one omega-3 fatty acid. Accordingly, the administration of at least one omega-6, one omega-3 fatty acids, or combination thereof is an effective strategy to prevent contact lens intolerance.

The term “omega-3 fatty acid” refers to fatty acids that have double bonds three carbon atoms from their omega carbon atom. For example, an omega-3 fatty acid includes, but is not limited to alpha linolenic acid (ALA). Other omega-3 fatty acids include derivatives of ALA being a fatty acid that is made by a chemical modification performed upon alpha linolenic acid. Examples of omega-3 fatty acids that are derivatives of ALA, include but are not limited to, eicosapentaenoic acid (EPA), and docosahexaenoic acid (DHA).

Linoleic acid, and gamma-linolenic acid (LA and GLA respectively) are omega-6 fatty acids because they have double bonds six carbons away from the omega carbon.

The solutions used in the exemplary methods of the present invention may be formed by dispersing or dissolving the selected fatty acids in a suitable carrier. Some carriers that may be suitable include water, saline solution, mineral oil, petroleum jelly, C.sub.15-20 alcohols, C.sub.15-20 amides, C.sub.15-20 alcohols substituted with zwitterions, combinations thereof and the like. Where the selected carrier cannot dissolve the fatty acids a surfactant may be added.

According to the preferred methods and embodiments of the invention, if a drop of solution containing omega-3 is applied to coat a contact lens, water evaporation from the contact lens will be reduced.

Direct installation of omega-3 internal to the contact lens in a manner that would not adversely effect oxygen transmissibility, will also limit water evaporation. Since contact lenses are comprised of polymers that mimic fatty acids, the external contact lens layer could contain a breathable omega-3 infusion and retain the water inside the contact lens, thus eliminating the propensity of the contact lens to remove aqueous (water) from the tear layer. An eyedrop or contact lens infusion containing omega-3 fatty acid should resolve contact lens intolerance.

Omega-3 fatty acid can be applied topically to an eye containing any contact lens material without side effects or damage to the contact lens as contact lenses are made of polymers containing fatty acid type properties. Contact lenses are made of polymers such as: balafilcon A, galyfilcon A, lotrafilcon, Alphafilcon A, as well as many other polymers that act like fatty acids in that they allow penetration of oxygen and retain a central zone of water.

The omega-3 fatty acids in a solution can replace the water saturated in, or held by, the contact lens and provide a longer evaporation time.

Since water evaporated from the contact lens is replaced from the tear layer, a low water lens works better in a dry eye (less evaporation of water). The omega-3 fatty acids can be incorporated within the polymer of the lens material and provide a longer evaporation time. Even the application of omega-3 drops to the lens in the eye or in a separate container may penetrate a contact lens to a sufficient degree and prevent evaporation causing contact lens intolerance.

Omega-3 fatty acids are available in over-the-counter dietary supplements that have been shown to improve meibomian gland functioning. When omega-3 fatty acids are applied directly into the eye, they act as a strong lubricant and wetting/rewetting agent. The omega-3 fatty acid can be dispensed without a preservative if provided in separate small plastic drop units that are common on the market, or with a preservative in a bottle format.

From the foregoing, it will be observed that numerous variations and modifications may be effected without departing from the spirit and scope of the invention. It is to be understood that no limitation with respect to the methods or embodiments herein is intended or should be inferred.

The invention claimed is:

1. A method of treating contact lens intolerance comprising the steps of:
providing a contact lens;
providing a solution comprising an essential fatty acid; and
applying said solution to a surface of said contact lens.

2. The method according to claim 1, wherein the step of providing is further defined in that said essential fatty acid is an omega-3 fatty acid.

3. The method according to claim 1, wherein the step of applying the solution is further defined by the steps of:
providing a container holding a supply of said solution, and soaking said contact lens in said container.

4. The method according to claim 1, wherein the step of applying the solution is further defined by the steps of:
providing a bottle of said solution, providing a container for holding said contact lens, and applying said solution onto said contact lens.

5. The method according to claim 1, wherein the step of providing is further defined in that said essential fatty acid is an omega-3 fatty acid, and wherein the step of applying the solution is further defined by the steps of:
providing a container holding a supply of said solution, and soaking said contact lens in said container.

6. The method according to claim 1, wherein the step of providing is further defined in that said essential fatty acid is an omega-3 fatty acid, and wherein the step of applying the solution is further defined by the steps of:
providing a dropper container holding a supply of said solution, and dispensing said solution by drops onto said contact lens.

7. A method of manufacturing contact lenses, comprising the steps of:
forming a contact lens;
providing a solution comprising an essential fatty acid; and
saturating said contact lens with said solution.

8. The method according to claim 7, wherein the step of providing is further defined in that said essential fatty acid is an omega-3 fatty acid.

9. A contact lens that is resistant to causing contact lens intolerance comprising a body portion forming a lens, wherein the body portion is saturated with an essential fatty acid

10. The contact lens according to claim 9, wherein said essential fatty acid comprises an omega-3 fatty acid.
